(19) United States
(12) Patent Application Publication
(10) Pub. No.: US 2021/0143434 A1
(43) Pub. Date: May 13, 2021

(54) ELECTRODE AND ALL-SOLID-STATE BATTERY

(71) Applicant: Toyota Jidosha Kabushiki Kaisha, Toyota-shi (JP)

(72) Inventor: Shingo Komura, Nagakute-shi (JP)

(21) Appl. No.: 17/092,707

(22) Filed: Nov. 9, 2020

(30) Foreign Application Priority Data
Nov. 11, 2019 (JP) 2019-204136

(51) Int. Cl. H01M 4/66; H01M 4/525; H01M 4/505; H01M 4/136; H01M 4/134; H01M 4/131; H01M 4/58; H01M 10/0525; H01M 10/0562

(52) U.S. Cl. CPC H01M 4/661; H01M 4/525; H01M 4/505; H01M 4/136; H01M 2004/028; H01M 4/131; H01M 4/58; H01M 10/0525; H01M 10/0562; H01M 4/134

(57) ABSTRACT

An electrode active material layer satisfies relations represented by an expression (1) “2.2≤X₀≤15.0” and an expression (2) “|(X₅−X₁)/X₁|≤25%”. X₀ represents a ratio of a mass concentration of a first component (Ni, Co, Mn, Al, Fe, Ti, Si) to a mass concentration of a second component (S, P) in a cross section of the electrode active material layer. X₁ represents a ratio of a mass concentration of the first component to a mass concentration of the second component in a region of the cross section closest to the electrode current collector; and X₅ represents a ratio of a mass concentration of the first component to a mass concentration of the second component in a region of the cross section farthest from the electrode current collector.

### CROSS REFERENCE TO RELATED APPLICATIONS

This nonprovisional application claims priority to Japanese Patent Application No. 2019-204136 filed on November 11, 2019, with the Japan Patent Office, the entire contents of which are hereby incorporated by reference.

### BACKGROUND

### Field

The present disclosure relates to an electrode and an all-solid-state battery.

### Description of the Background Art

Japanese Patent Laying-Open No. 2012-104270 discloses changing the ratio of the volume of an electrode active material to the volume of a solid electrolyte in a thickness direction of an electrode.

### SUMMARY

Research has been underway for all-solid-state batteries. Sulfide solid electrolyte has been a promising electrolyte for all-solid-state batteries. It is because sulfide solid electrolyte has a high lithium (Li) ion conductivity.

An electrode of an all-solid-state battery is produced by a wet process. More specifically, an electrode active material, a sulfide solid electrolyte, a dispersion medium, and the like are mixed to prepare a slurry, and the resulting slurry is applied to a surface of an electrode current collector and dried to form an electrode active material layer.

The electrode active material and the sulfide solid electrolyte have different specific gravities. Therefore, in the electrode active material layer thus obtained by a wet process, the dispersion state tends to be non-uniform. More specifically, in a thickness direction of the electrode active material layer, the sulfide solid electrolyte tends to be localized closer to the surface and the electrode active material tends to be localized closer to the electrode current collector. This can inhibit smooth ionic conduction in the thickness direction, leading to an increased battery resistance.

An object of the present disclosure is to reduce battery resistance.

In the following, the technical structure and the effects according to the present disclosure are described. It should be noted that the action mechanism according to the present disclosure includes presumption. The scope of claims is not limited by whether or not the action mechanism according to the present disclosure is correct.

[1] An electrode includes an electrode current collector and an electrode active material layer. The electrode active material layer is formed on a surface of the electrode current collector. The electrode active material layer includes an electrode active material and a sulfide solid electrolyte.

The electrode active material includes a first component. The first component consists of at least one selected from the group consisting of nickel (Ni), cobalt (Co), manganese (Mn), aluminum (Al), iron (Fe), titanium (Ti), and silicon (Si).

The sulfide solid electrolyte includes a second component. The second component consists of sulfur (S) and phosphorus (P).

The electrode active material layer satisfies relations represented by the following expression (1) and the following expression (2):

2.2≤X₀≤15.0 (1)

|(X₅−X₁)/X₁|≤25% (2)

In the expression (1), X₀ represents a ratio of a mass concentration of the first component to a mass concentration of the second component in a region of a cross section of the electrode active material layer parallel to a thickness direction of the electrode active material layer, where the region stretches for an entire thickness of the electrode active material layer.

In the expression (2), X₁ represents a ratio of a mass concentration of the first component to a mass concentration of the second component in a region of the cross section, where the region is associated with a single unit layer among five unit layers that result from equally dividing the electrode active material layer in the thickness direction and the single unit layer is the closest to the electrode current collector among the five unit layers; and X₅ represents a ratio of a mass concentration of the first component to a mass concentration of the second component in a region of the cross section, where the region is associated with a single unit layer that is the farthest from the electrode current collector among the five unit layers.

When the electrode active material does not include phosphorus, the mass concentration of the second component is defined as a sum of a mass concentration of sulfur and a mass concentration of phosphorus. When the electrode active material includes phosphorus, the mass concentration of the second component is defined as the mass concentration of sulfur.

The present disclosure has newly found that when the relations represented by the expression (1) and the expression (2) are satisfied for the electrode active material layer, battery resistance tends to be reduced.

It is considered that “X₀” in the expression (1) represents the average ratio between the electrode active material and the sulfide solid electrolyte in the entire electrode active material layer. When “X₀” is lower than 2.2, the amount of the electrode active material is excessively low and thereby capacity may be insufficient. As a result, regardless of the dispersion state of the electrode active material and the sulfide solid electrolyte, battery resistance may increase. When “X₀” exceeds 15.0, the amount of sulfide solid electrolyte is excessively low and thereby the ionic conduction may be inactive. As a result, regardless of the dispersion state of the electrode active material and the sulfide solid electrolyte, battery resistance may increase. “X₀” is calculated from results of analysis conducted with an SEM-EDX (Scanning Electron Microscope Energy Dispersive X-Ray spectrometer). “X₀” may be adjusted by changing the mixing ratio between the electrode active material and the sulfide solid electrolyte, for example.

It is considered that “X₁” in the expression (2) represents the ratio between the electrode active material and the sulfide solid electrolyte in a bottom portion of the electrode active material layer. It is considered that “X₅” represents the ratio between the electrode active material and the sulfide solid electrolyte in a top portion of the electrode active material layer. “|(X₅−X₁)/X₁|” may serve as an index of the dispersion state of the electrode active material and the sulfide solid electrolyte in the thickness direction of the electrode active material layer. Hereinafter, “|(X₅−X₁)/X₁|” is also called “|ΔX|”.

It is considered that the smaller the “|ΔX|” is, the more uniformly the electrode active material and the sulfide solid electrolyte are dispersed. When “|ΔX|” is 25% or less, battery resistance tends to be reduced. It may be because ionic conduction in the thickness direction of the electrode active material layer is smooth.

“|ΔX|” is calculated from results of analysis conducted with an SEM-EDX. “|ΔX|” may be adjusted by changing conditions of slurry preparation.

[2] In the electrode according to [1] above, the electrode active material may be a positive electrode active material.

The positive electrode active material may include at least one selected from the group consisting of a lithium-nickel-cobalt-manganese composite oxide, a lithium-nickel-cobalt-aluminum composite oxide, and a lithium iron phosphate, for example.

The electrode according to [1] above may be a positive electrode. The lithium-nickel-cobalt-manganese composite oxide includes Ni, Co, and/or Mn. The lithium-nickel-cobalt-aluminum composite oxide includes Al. The lithium iron phosphate includes Fe and/or P.

[3] In the electrode according to [1] above, the electrode active material may be a negative electrode active material.

The negative electrode active material may include at least one selected from the group consisting of a lithium-titanium composite oxide, a silicon oxide, and silicon, for example.

The electrode according to [1] above may be a negative electrode. The lithium-titanium composite oxide includes Ti. The silicon oxide includes Si.

[4] An all-solid-state battery includes the electrode according to any one of [1] to [3] above.

The all-solid-state battery is expected to have a low battery resistance. It may be because ionic conduction in the thickness direction of the electrode active material layer is smooth.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual cross-sectional view of an electrode according to the present embodiment.

FIG. 2 is a descriptive view for describing a cross-sectional analysis of an electrode active material layer.

FIG. 3 is a schematic flowchart of a method of producing an electrode according to the present embodiment.

FIG. 4 is a conceptual cross-sectional view of an all-solid-state battery according to the present embodiment.

### DETAILED DESCRIPTION

Herein, phrases such as “from 1 part by mass to 10 parts by mass” mean a range that includes the boundary values, unless otherwise specified. For example, the phrase “from 1 part by mass to 10 parts by mass” means a range of “not less than 1 part by mass and not more than 10 parts by mass”.

In the following, embodiments of the present disclosure (hereinafter also called “present embodiment”) are described. However, the description below does not limit the scope of claims.

<Electrode>

FIG. 1 is a conceptual cross-sectional view of an electrode according to the present embodiment.

An electrode 100 according to the present embodiment is for an all-solid-state battery. The all-solid-state battery is described below in detail. Electrode 100 may be a positive electrode. Electrode 100 may be a negative electrode. Electrode 100 is in sheet form. Electrode 100 may have any planar profile. Electrode 100 includes an electrode current collector 110 and an electrode active material layer 120.

«Electrode Current Collector»

Electrode current collector 110 is in sheet form. Electrode current collector 110 may have a thickness from 5 μm to 50 μm, for example. Electrode current collector 110 is electronically conductive. Electrode current collector 110 may include a metal foil, for example. Electrode current collector 110 may include at least one selected from the group consisting of Al, Ni, and copper (Cu), for example. When electrode 100 is a positive electrode, electrode current collector 110 may be an Al foil, for example. When electrode 100 is a negative electrode, electrode current collector 110 may be a Ni foil and/or a Cu foil, for example.

«Electrode Active Material Layer»

Electrode active material layer 120 is formed on a surface of electrode current collector 110. Electrode active material layer 120 may be formed on only one side of electrode current collector 110. Electrode active material layer 120 may be formed on both sides of electrode current collector 110.

Electrode active material layer 120 may be formed directly on a surface of electrode current collector 110. Between electrode active material layer 120 and electrode current collector 110, a conductive layer (not illustrated) may be formed, for example. The conductive layer may include a conductive material and a binder, for example. According to the present embodiment, even in a case in which an object such as a conductive layer is interposed between electrode active material layer 120 and electrode current collector 110, electrode active material layer 120 is still regarded as being formed on a surface of electrode current collector 110.

Electrode active material layer 120 includes an electrode active material 1 and a sulfide solid electrolyte 2. Electrode active material layer 120 may further include a conductive material (not illustrated) and a binder (not illustrated).

(Electrode Active Material)

Electrode active material 1 is in the form of particles. Electrode active material 1 may have a median size from 1 μm to 30 μm, for example. The “median size” according to the present embodiment refers to a particle size in volume-based particle size distribution at which the cumulative particle volume (accumulated from the side of small sizes) reaches 50% of the total particle volume. The median size may be measured with a laser-diffraction particle size distribution analyzer. Electrode active material 1 may have a median size from 5 μm to 20 μm, for example. Electrode active material 1 includes a first component. The first component consists of at least one selected from the group consisting of Ni, Co, Mn, Al, Fe, Ti, and Si. The first component constitutes a host substance. The host substance incorporates and releases a guest substance (Li ions) through oxidation-reduction reaction.

(Positive Electrode Active Material)

When electrode 100 is a positive electrode, electrode active material 1 is a positive electrode active material. The positive electrode active material may include at least one selected from the group consisting of a lithium-nickel-cobalt-manganese composite oxide (which may be abbreviated as “NCM” hereinafter), a lithium-nickel-cobalt-aluminum composite oxide (which may be abbreviated as “NCA” hereinafter), and a lithium iron phosphate (which may be abbreviated as “LFP” hereinafter), for example.

“NCM” is a composite oxide including Li, Ni, Co, and Mn. NCM may further include other elements in addition to Li, Ni, Co, Mn, and oxygen (O). NCM may be represented by the following general formula, for example: Li(Niₐ₁Co_{b1}Mn_{1-a1-b1})O₂. In the formula, relations “0<a1<1, 0<b1<1, 0<(1−a1−b1)<1” may be satisfied, for example. In the formula, relations “0.2<a1<0.5, 0.2<b1<0.5, 0.2<(1−a1−b1)<0.5” may be satisfied, for example.

“NCA” is a composite oxide including Li, Ni, Co, and Al. NCA may further include other elements in addition to Li, Ni, Co, Al, and O. NCA may be represented by the following general formula, for example: Li(Niₐ₂Co_{b2}Al_{1-a2-b2})O₂. In the formula, relations “0<a2<1, 0<b2<1, 0<(1−a2−b2)<1” may be satisfied, for example. In the formula, relations “0.6<a2<1, 0<b2<0.4, 0<(1−a2−b2)<0.4” may be satisfied, for example. In the formula, relations “0.7<a2<0.9, 0.1<b2<0.2, 0<(1−a2−b2)<0.1” may be satisfied, for example.

“LFP” is a composite phosphate including Li and Fe. LFP is represented by the following compositional formula: LiFePO₄. LFP may further include other elements in addition to Li, Fe, P, and O.

(Negative Electrode Active Material)

When electrode 100 is a negative electrode, electrode active material 1 is a negative electrode active material. The negative electrode active material may include at least one selected from the group consisting of a lithium-titanium composite oxide (which may be abbreviated as “LTO” hereinafter), a silicon oxide (SiO), and Si, for example.

“LTO” is a composite oxide including Li and Ti. LTO may have any chemical composition. LTO may have a chemical composition of Li₄Ti₅O₁₂, for example.

“SiO” refers to a compound including Si and O. The composition ratio between Si and O in SiO is not limited. For example, a relation (molar ratio) from “Si/O=1/0.1” to “Si/O=1/2” may be satisfied. For example, a relation (molar ratio) from “Si/O=1/0.5” to “Si/O=1/1.5” may be satisfied.

(Sulfide Solid Electrolyte)

Sulfide solid electrolyte 2 is in the form of particles. In FIG. 1, for the sake of convenience, sulfide solid electrolyte 2 is not illustrated as particles. Sulfide solid electrolyte 2 may have a median size from 0.1 μm to 5 μm, for example. Sulfide solid electrolyte 2 may have a median size from 0.1 μm to 1 μm, for example.

Sulfide solid electrolyte 2 is Li-ion conductive. Sulfide solid electrolyte 2 is not electronically conductive. Sulfide solid electrolyte 2 may be glass, for example. Sulfide solid electrolyte 2 may be glass ceramics (also called “crystallized glass”), for example.

Sulfide solid electrolyte 2 includes a second component. The second component consists of S and P. As long as including the second component, sulfide solid electrolyte 2 may further include other components. These other components may be, for example, a halogen element (such as iodine, bromine), a carbon group element (such as germanium), an oxygen group element (except S), and the like.

Sulfide solid electrolyte 2 may include at least one selected from the group consisting of Li₂S—P₂S₅, LiI—LiBr—Li₂S—P₂S₅, LiI—Li₂S—P₂S₅, LiBr—Li₂S—P₂S₅, Li₂O—Li₂S—P₂S₅, LiI—Li₃PO₄—P₂S₅, and Li₂S—P₂S₅—GeS₂, for example. These listed materials may be included in electrode 100 and a separator 300 (described below) in common.

For example, “Li₂S—P₂S₅” means that sulfide solid electrolyte 2 consists of a component derived from Li₂S and a component derived from P₂S₅. Li₂S—P₂S₅ may be produced by mechanochemical reaction of Li₂S and P₂S₅, for example. In particular, a sulfide solid electrolyte 2 that includes a component derived from Li₂S and a component derived from P₂S₅ is also called “Li₂S—P₂S₅-type solid electrolyte”. The mixing ratio between Li₂S and P₂S₅ is not limited. Li₂S and P₂S₅ may satisfy a relation (molar ratio) from “Li₂S/P₂S₅=50/50” to “Li₂S/P₂S₅=90/10”, for example. Li₂S and P₂S₅ may satisfy a relation (molar ratio) from “Li₂S/P₂S₅=60/40” to “Li₂S/P₂S₅=80/20”, for example.

In front of each component symbol, a number may be placed. This number indicates the proportion of the component. For example, “10LiI-10LiBr-80(0.75Li₂S-0.25P₂S₅)” indicates that LiI, LiBr, and 0.75Li₂S-0.25P₂S₅ satisfy the following relation (molar ratio): “LiI/LiBr/0.75Li₂S-0.25P₂S₅=10/10/80”. 0.75Li₂S-0.25P₂S₅ indicates that Li₂S and P₂S₅ satisfy the following relation (molar ratio): “Li₂S/P₂S₅=75/25”.

(Conductive Material)

The conductive material is electronically conductive. The conductive material may include any component. The conductive material may include at least one selected from the group consisting of carbon black (such as acetylene black), graphite, vapor grown carbon fiber (VGCF), carbon nanotube (CNT), and graphene flake, for example. The amount of the conductive material may be, for example, from 0.1 parts by mass to 10 parts by mass relative to 100 parts by mass of electrode active material 1.

(Binder)

The binder combines solids together. The binder may include any component. The binder may include at least one selected from the group consisting of polyvinylidene difluoride (PVdF), polytetrafluoroethylene (PTFE), butyl rubber (IIR), styrene-butadiene rubber (SBR), polyacrylic acid (PAA), and carboxymethylcellulose (CMC), for example. The binder may have voltage endurance. The binder may have a low reactivity with sulfide solid electrolyte 2. For example, PVdF may have voltage endurance. For example, PVdF has a low reactivity with sulfide solid electrolyte 2. The amount of the binder may be, for example, from 0.1 parts by mass to 10 parts by mass relative to 100 parts by mass of electrode active material 1.

«Dispersion State»

Electrode active material layer 120 according to the present embodiment has a particular dispersion state.

More specifically, electrode active material layer 120 satisfies relations represented by the following expressions (1) and (2):

2.2≤X₀≤15.0 (1)

|(X₅−X₁)/X₁|≤25% (2)

It is considered that “X₀” in the expression (1) represents the average ratio between electrode active material 1 and sulfide solid electrolyte 2 in the entire electrode active material layer 120. When “X₀” is lower than 2.2, the amount of electrode active material 1 is excessively low and thereby capacity may be insufficient. As a result, regardless of the dispersion state of electrode active material 1 and sulfide solid electrolyte 2, battery resistance may increase. When “X₀” exceeds 15.0, the amount of sulfide solid electrolyte 2 is excessively low and thereby the ionic conduction may be inactive. As a result, regardless of the dispersion state of electrode active material 1 and sulfide solid electrolyte 2, battery resistance may increase.

“X₀” may be 2.4 or more, for example. “X₀” may be 5.0 or more, for example. “X₀” may be 5.0 or less, for example.

It is considered that “X₁” in the expression (2) represents the ratio between electrode active material 1 and sulfide solid electrolyte 2 in a bottom portion of electrode active material layer 120. It is considered that “X₅” represents the ratio between electrode active material 1 and sulfide solid electrolyte 2 in a top portion of electrode active material layer 120. “|ΔX|=|(X₅−X₁)/X₁|” may serve as an index of the dispersion state of electrode active material 1 and sulfide solid electrolyte 2 in the thickness direction of electrode active material layer 120.

It is considered that the smaller the “|ΔX|” is, the more uniformly electrode active material 1 and sulfide solid electrolyte 2 are dispersed. When “|ΔX|” is 25% or less, battery resistance tends to be reduced. It may be because ionic conduction in the thickness direction of electrode active material layer 120 is smooth.

“|ΔX|” may be 8% or less, for example. “|ΔX|” may be 4% or less, for example. “|ΔX|” may be 2% or less, for example. “|ΔX|” may be 0%, for example.

«Measurement Method»

FIG. 2 is a descriptive view for describing a cross-sectional analysis of an electrode active material layer. “X₀” and “|ΔX|” are measured in a cross section of electrode active material layer 120. The xz plane in FIG. 2 corresponds to a cross-sectional sample of electrode active material layer 120. The z-axis direction in FIG. 2 corresponds to the thickness direction of electrode active material layer 120. In other words, the cross-sectional sample is parallel to the thickness direction. However, the “parallel” according to the present embodiment does not mean “parallel” in a strict sense. According to the present embodiment, a relation that is outside but close to the geometrically completely parallel is also tolerated. The angle formed by the cross-sectional sample and the thickness direction may be 0 degree to 10 degrees.

First, electrode 100 is cut with a box cutter or the like at a predetermined position. Thus, a cross-sectional sample is obtained. An ion milling apparatus is used to clean a surface of the cross-sectional sample. After cleaning, the cross-sectional sample is examined with an SEM. The magnification for the examination is adjusted so that the entire thickness of electrode active material layer 120 fits within the field of view.

A measurement region R₀ is designated. Measurement region R₀ is a rectangular region. The outer edge of measurement region R₀ corresponds to the outer edge of electrode active material layer 120 in the thickness direction. In other words, measurement region R₀ is a region of the cross section of electrode active material layer 120 that stretches for the entire thickness of electrode active material layer 120.

For measurement region R₀, the mass concentration of the first component is measured with an EDX. When the first component includes multiple components, the sum of the mass concentrations of the components is regarded as the mass concentration of the first component. For example, when the positive electrode active material is NCM, the sum of the Ni mass concentration, the Co mass concentration, and the Mn mass concentration is regarded as the mass concentration of the first component.

For measurement region R₀, the mass concentration of the second component is measured with an EDX. When electrode active material 1 does not include P, the S mass concentration and the P mass concentration are measured. The sum of the S mass concentration and the P mass concentration is regarded as the mass concentration of the second component.

When electrode active material 1 includes P, the S mass concentration is measured. When electrode active material 1 includes P, the P mass concentration is excluded from the second component. The S mass concentration alone is regarded as the mass concentration of the second component. Such a case in which electrode active material 1 includes P may be, for example, a case in which electrode active material 1 is LFP.

It is considered that the measurement results for measurement region R₀ indicate the average mass concentrations of the components in the entire cross section. The mass concentration of the first component in measurement region R₀ is divided by the mass concentration of the second component in measurement region R₀ to obtain “X₀”. The result of division is significant to one decimal place. It is rounded to one decimal place.

FIG. 2 includes the following expression (3) as an example.

For example, when electrode active material 1 is NCM, “X₀” is calculated by the following expression (3):

X₀=(C_{Ni}+C_{Co}+C_{Mn})/(C_{S}+C_{P}) (3)

For example, “C_{Ni}” in the expression (3) represents the Ni mass concentration. For example “C_{S}” represents the S mass concentration. The same applies to the following expressions (4) to (9).

For example, when electrode active material 1 is NCA, “X₀” is calculated by the following expression (4):

X₀═(C_{Ni}+C_{Co}+C_{A1})/(C_{S}+C_{P}) (4)

For example, when electrode active material 1 is LFP, “X₀” is calculated by the following expression (5):

X₀═C_{Fe}/C_{S} (5)

For example, when electrode active material 1 includes NCM and LFP, “X₀” is calculated by the following expression (6):

X₀═(C_{Ni}+C_{Co}+C_{Mn}+C_{Fe})/C_{S} (6)

For example, when electrode active material 1 is LTO, “X₀” is calculated by the following expression (7):

X₀═C_{Ti}/(C_{S}+C_{P}) (7)

For example, when electrode active material 1 includes at least one of SiO and Si, “X₀” is calculated by the following expression (8):

X₀═C_{Si}/(C_{S}C_{P}) (8)

For example, when electrode active material 1 includes LTO and Si, “X₀” is calculated by the following expression (9):

X₀═(C_{Ti}+C_{Si})/(C_{S}+C_{P}) (9)

Then, electrode active material layer 120 is equally divided into five unit layers in the thickness direction. More specifically, electrode active material layer 120 is imaginarily divided into the following five layers: a first unit layer 121, a second unit layer 122, a third unit layer 123, a fourth unit layer 124, and a fifth unit layer 125.

The unit layer closest to electrode current collector 110 is selected. The unit layer closest to electrode current collector 110 is first unit layer 121. Within first unit layer 121, a measurement region R₁ is designated. Measurement region R₁ is a rectangular region. The outer edge of measurement region R₁ corresponds to the outer edge of first unit layer 121 in the thickness direction.

For measurement region R₁, the mass concentration of the first component is measured with an EDX. When the first component includes multiple components, the sum of the mass concentrations of the components is regarded as the mass concentration of the first component. For example, when the positive electrode active material is NCM, the sum of the Ni mass concentration, the Co mass concentration, and the Mn mass concentration is regarded as the mass concentration of the first component.

For measurement region R₁, the mass concentration of the second component is measured with an EDX. When electrode active material 1 does not include P, the S mass concentration and the P mass concentration are measured. The sum of the S mass concentration and the P mass concentration is regarded as the mass concentration of the second component.

When electrode active material 1 includes P, the S mass concentration is measured. The S mass concentration alone is regarded as the mass concentration of the second component.

The mass concentration of the first component in measurement region R₁ is divided by the mass concentration of the second component in measurement region R₁ to obtain “X₁”. The result of division is significant to one decimal place. It is rounded to one decimal place.

The unit layer farthest from electrode current collector 110 is selected. The unit layer farthest from electrode current collector 110 is fifth unit layer 125. Within fifth unit layer 125, a measurement region R₅ is designated. Measurement region R₅ is a rectangular region. The area of measurement region R₅ is substantially the same as that of measurement region R₁. The outer edge of measurement region R₅ corresponds to the outer edge of fifth unit layer 125 in the thickness direction.

In the same manner as for measurement region R₁, the mass concentration of each of the first component and the second component is measured for measurement region R₅. The mass concentration of the first component in measurement region R₅ is divided by the mass concentration of the second component in measurement region R₅ to obtain “X₅”. The result of division is significant to one decimal place. It is rounded to one decimal place.

“X₁” and “X₅” are substituted into the left side of the expression (2) to calculate “|ΔX|”. “|ΔX|” is expressed in percentage. After converted into percentage, the number is rounded to the nearest integer.

Five cross-sectional samples are prepared. These cross-sectional samples are taken at different positions. The positions of the cross-sectional samples in electrode 100 are randomly selected. For each of the five cross-sectional samples, “X₀” and “|ΔX|” are measured. The arithmetic mean of the resulting five “X₀” values is regarded as “X₀” of electrode active material layer 120 of interest. The arithmetic mean of the five “|ΔX|” values is regarded as “|ΔX|” of electrode active material layer 120 of interest.

<Method of Producing Electrode>

FIG. 3 is a schematic flowchart of a method of producing an electrode according to the present embodiment.

According to the present embodiment, a method of producing an electrode is also provided. The method of producing an electrode according to the present embodiment includes (A) and (B) below:

(A) preparing a slurry by mixing electrode active material 1, sulfide solid electrolyte 2, and a dispersion medium; and

(B) forming electrode active material layer 120 by applying the slurry to a surface of electrode current collector 110 and drying. Electrode active material layer 120 satisfies the expression (1) and the expression (2).

The slurry may be prepared so as to further include, for example, a conductive material and a binder. The dispersion medium may include a carboxylate ester, for example. A dispersion medium based on a carboxylate ester tends to have a low reactivity with sulfide solid electrolyte 2. The dispersion medium may include butyl butyrate, for example.

The mixing ratio between electrode active material 1 and sulfide solid electrolyte 2 is set so as to satisfy the expression (1). So as to satisfy the expression (1), conditions (p) and (q) below may need to be satisfied, for example. So as to increase the interface of contact between electrode active material 1 and sulfide solid electrolyte 2, a condition (r) below may also need to be satisfied.

(p) The ratio of the electrode active material in the slurry is high. For example, the ratio accounted for by electrode active material 1 in solid matter is 64 mass % or more.

(q) The NV (nonvolatile) value of the slurry is relatively high. For example, the NV value is 51 mass % or more. The “NV value” refers to the mass ratio of components except the dispersion medium.

(r) The median size of sulfide solid electrolyte 2 is small compared to that of electrode active material 1. For example, sulfide solid electrolyte 2 has a median size from 0.1 μm to 5 μm.

In general, when conditions (p), (q), and (r) are satisfied, particle aggregation tends to occur in the slurry. As a result, it becomes difficult to satisfy the expression (2). So as to satisfy the expression (2), procedures (s), (t), and (u) below, for example, may be carried out to reduce particle aggregation.

(s) The materials may be added to the dispersion medium in descending order of specific surface area, and each time a material is added, the material may be dispersed. For example, the materials may be added to the dispersion medium in the following order: “binder→conductive material→sulfide solid electrolyte→electrode active material”.

(t) The dispersion operation thus performed each time a material is added may apply a heavy shearing load to the dispersed matter (particles). For example, an ultrasonic homogenizer may be used. For example, each time a material is added, the dispersion operation may be continued until the particle size reaches 40 μm or less. The phrase “the particle size reaches 40 μm or less” means that 85% or more of the dispersion system passes through a sieve with an aperture size of 40 μm.

(u) To avoid degradation of the binder and the dispersion medium, the temperature of the dispersion system may be controlled. Degradation of the binder and the dispersion medium (gelation, for example) can promote particle aggregation. For example, when the temperature of the dispersion system is high, degradation of the binder and the dispersion medium can proceed. Therefore, from the time of addition of the materials to the completion of slurry preparation, for example, the temperature of the dispersion system may be controlled at 45° C. or lower.

Slurry application may be performed with any applicator. Slurry drying may be performed with any dryer.

<All-Solid-State Battery>

FIG. 4 is a conceptual cross-sectional view of an all-solid-state battery according to the present embodiment. An all-solid-state battery 1000 includes electrode 100, separator 300, and a counter electrode 200. Separator 300 separates electrode 100 from counter electrode 200. Electrode 100, separator 300, and counter electrode 200 together may form a unit stacked body. All-solid-state battery 1000 may include a single unit stacked body. All-solid-state battery 1000 may include a plurality of unit stacked bodies. The plurality of unit stacked bodies may be stacked in one direction.

All-solid-state battery 1000 may include a case (not illustrated). The case may accommodate electrode 100, separator 300, and counter electrode 200. The case may have any configuration. The case may be a pouch made of an Al-laminated film, for example. The case may be a metal casing, for example.

«Counter Electrode»

Counter electrode 200 has a polarity opposite to the polarity of electrode 100. When electrode 100 is a positive electrode, counter electrode 200 is a negative electrode. When electrode 100 is a negative electrode, counter electrode 200 is a positive electrode.

Counter electrode 200 may also have the configuration according to the present embodiment. More specifically, the expressions (1) and (2) may also be satisfied for counter electrode 200. In this case, the expressions (1) and (2) are satisfied for both the positive electrode and the negative electrode. When the expressions (1) and (2) are satisfied for both the positive electrode and the negative electrode, battery resistance may be reduced.

«Separator»

Separator 300 is interposed between electrode 100 and counter electrode 200. Separator 300 may have a thickness from 1 μm to 30 μm, for example. Separator 300 is closely adhered to electrode 100. Separator 300 is also closely adhered to counter electrode 200. Separator 300 is Li-ion conductive. Separator 300 is not electronically conductive.

Separator 300 includes sulfide solid electrolyte 2. Separator 300 may include Li₂S—P₂S₅-type solid electrolyte, for example. Separator 300 may consist essentially of sulfide solid electrolyte 2. Separator 300 may further include a binder and the like. The binder may include butyl rubber and/or PVdF, for example. The amount of the binder may be from 0.1 parts by mass to 10 parts by mass relative to 100 parts by mass of sulfide solid electrolyte 2.

### EXAMPLES

Next, examples according to the present disclosure (herein also called “the present example”) are described. However, the description below does not limit the scope of claims.

### Experiment 1: Comparative Example 1 to Comparative Example 8, Example 1 to Example 10

In Experiment 1, a positive electrode was evaluated.

«Producing All-Solid-State Battery»

1. Producing Positive Electrode

The materials described below were prepared.

Electrode active material: Li(Ni_{1/3}Co_{1/3}Mn_{1/3})O₂

Sulfide solid electrolyte: 10LiI-10LiBr-80(0.75Li₂S-0.25P₂S₅)

Conductive material: acetylene black, VGCF

Binder: PVdF

Dispersion medium: butyl butyrate

Positive electrode current collector: Al foil

The binder, the conductive material, the sulfide solid electrolyte, and the electrode active material were added to the dispersion medium in this order. More specifically, the materials were added to the dispersion medium in descending order of specific surface area. Each time a material was added, the material was dispersed with an ultrasonic homogenizer. Each dispersion operation with an ultrasonic homogenizer was continued until the particle size reached 40 μm or less. In this way, a slurry was prepared. At all times from the start of material addition to the completion of slurry, the temperature of the dispersion system was controlled at 45° C. or lower.

The slurry was applied to a surface of a positive electrode current collector and dried to form an electrode active material layer. In this way, a positive electrode was produced.

“Composition ratio” and “NV value” of the slurry were changed as specified in Table 1 below to produce a positive electrode according to each Example.

2. Producing Negative Electrode

The materials described below were prepared.

Electrode active material: Li₄Ti₅O₁₂

Sulfide solid electrolyte: 10LiI-10LiBr-80(0.75Li₂S-0.25P₂S₅)

Conductive material: acetylene black, VGCF

Binder: PVdF

Dispersion medium: butyl butyrate

Negative electrode current collector: Ni foil

The binder, the conductive material, the sulfide solid electrolyte, and the electrode active material were added to the dispersion medium. The mixture was stirred to prepare a slurry. The slurry was applied to a surface of a negative electrode current collector and dried to produce a negative electrode.

3. Producing Separator

The materials described below were prepared.

Sulfide solid electrolyte: 10LiI-10LiBr-80(0.75Li₂S-0.25P₂S₅)

Dispersion medium: butyl butyrate

A binder and the sulfide solid electrolyte were added to the dispersion medium. The mixture was stirred to prepare a slurry. The slurry was applied to a surface of a base material and dried to produce a separator. The mixing ratio between the sulfide solid electrolyte and the binder was “(sulfide solid electrolyte)/binder=96/4” (mass ratio).

4. Assembly

The positive electrode, the separator, and the negative electrode were stacked in this order to form a unit stacked body. A pouch made of an Al-laminated film was prepared as a case. In the case thus prepared, the unit stacked body was placed. In this way, an all-solid-state battery was produced.

»Evaluation»

1. X₀, |ΔX|In the above-described manner, “X₀” and “|ΔX|” for the positive electrode were measured. Results are shown in Table 1 below.

2. Battery Resistance

The SOC (State of Charge) of the all-solid-state battery was adjusted to 50%. In an environment at a temperature of 25° C., the all-solid-state battery was discharged at a rate of 3 C for 10 seconds. From the level of voltage drop at 10 seconds from the start of discharging, battery resistance was calculated. Results are shown in Table 1 below. The “C” is the unit of rate. At a rate of 1 C, a battery is fully discharged from its full charge capacity in one hour.

TABLE 1

| | Electrode active material layer | | | | | | | | All-solid-state |
|---|---|---|---|---|---|---|---|---|---|
| | | Composition ratio (mass ratio) | | | | Slurry | Expression | Expression | battery |
| | | Electrode | Sulfide | | | NV | (1) | (2) | Battery |
| | Positive electrode | active | solid | Conductive | | value | X₀ | [ΔX] | resistance |
| | active material | material | electrolyte | material | Binder | [mass %] | [−] | [%] | [Ω] |
| Comp. Ex. 1 | Li(Ni_{1/3}Mn_{1/3}Co_{1/3})O₂ | 0.600 | 0.300 | 0.050 | 0.050 | 71 | 2.0 | 2 | 10.2 |
| Comp. Ex. 2 | Li(Ni_{1/3}Mn_{1/3}Co_{1/3})O₂ | 0.600 | 0.300 | 0.050 | 0.050 | 55 | 2.0 | 25 | 9.4 |
| Ex. 1 | Li(Ni_{1/3}Mn_{1/3}Co_{1/3})O₂ | 0.635 | 0.289 | 0.040 | 0.040 | 71 | 2.2 | 2 | 5.0 |
| Ex. 2 | Li(Ni_{1/3}Mn_{1/3}Co_{1/3})O₂ | 0.635 | 0.289 | 0.040 | 0.040 | 55 | 2.2 | 8 | 5.2 |
| Ex. 3 | Li(Ni_{1/3}Mn_{1/3}Co_{1/3})O₂ | 0.635 | 0.289 | 0.040 | 0.040 | 51 | 2.2 | 25 | 8.2 |
| Comp. Ex. 3 | Li(Ni_{1/3}Mn_{1/3}Co_{1/3})O₂ | 0.635 | 0.289 | 0.040 | 0.040 | 41 | 2.2 | 26 | 9.8 |
| Ex. 4 | Li(Ni_{1/3}Mn_{1/3}Co_{1/3})O₂ | 0.750 | 0.150 | 0.050 | 0.050 | 71 | 5.0 | 2 | 4.2 |
| Ex. 5 | Li(Ni_{1/3}Mn_{1/3}Co_{1/3})O₂ | 0.750 | 0.150 | 0.050 | 0.050 | 62 | 5.0 | 4 | 4.9 |
| Ex. 6 | Li(Ni_{1/3}Mn_{1/3}Co_{1/3})O₂ | 0.750 | 0.150 | 0.050 | 0.050 | 55 | 5.0 | 8 | 5.0 |
| Ex. 7 | Li(Ni_{1/3}Mn_{1/3}Co_{1/3})O₂ | 0.750 | 0.150 | 0.050 | 0.050 | 51 | 5.0 | 25 | 6.1 |
| Comp. Ex. 4 | Li(Ni_{1/3}Mn_{1/3}Co_{1/3})O₂ | 0.750 | 0.150 | 0.050 | 0.050 | 41 | 5.0 | 26 | 9.3 |
| Comp. Ex. 5 | Li(Ni_{1/3}Mn_{1/3}Co_{1/3})O₂ | 0.750 | 0.150 | 0.050 | 0.050 | 35 | 5.0 | 33 | 10.0 |
| Ex. 8 | Li(Ni_{1/3}Mn_{1/3}Co_{1/3})O₂ | 0.853 | 0.057 | 0.050 | 0.040 | 71 | 15.0 | 2 | 4.0 |
| Ex. 9 | Li(Ni_{1/3}Mn_{1/3}Co_{1/3})O₂ | 0.853 | 0.057 | 0.050 | 0.040 | 55 | 15.0 | 8 | 4.8 |
| Ex. 10 | Li(Ni_{1/3}Mn_{1/3}Co_{1/3})O₂ | 0.853 | 0.057 | 0.050 | 0.040 | 51 | 15.0 | 25 | 5.5 |
| Comp. Ex. 6 | Li(Ni_{1/3}Mn_{1/3}Co_{1/3})O₂ | 0.853 | 0.057 | 0.050 | 0.040 | 41 | 15.0 | 26 | 9.2 |
| Comp. Ex. 7 | Li(Ni_{1/3}Mn_{1/3}Co_{1/3})O₂ | 0.900 | 0.050 | 0.020 | 0.030 | 71 | 18.0 | 2 | 10.5 |
| Comp. Ex. 8 | Li(Ni_{1/3}Mn_{1/3}Co_{1/3})O₂ | 0.900 | 0.050 | 0.020 | 0.030 | 55 | 18.0 | 25 | 9.6 |

«Results»

As illustrated in Table 1 above, when the electrode active material layer satisfies the expression (1) and the expression (2), battery resistance tends to be low.

### Experiment 2: Comparative Example 9 to Comparative Example 14, Example 11 to Example 14

In Experiment 2, a positive electrode was evaluated.

«Producing All-Solid-State Battery»

Except that “Positive electrode active material”, “Composition ratio”, and “NV value” were changed as specified in Table 2 below, the same manner as in Experiment 1 was adopted to produce an electrode and an all-solid-state battery.

«Evaluation»

In the same manner as in Experiment 1, “X₀” and “|ΔX|” for the positive electrode as well as battery resistance were measured. Results are shown in Table 2 below.

TABLE 2

| | Electrode active material layer | | | | | | | | All-solid-state |
|---|---|---|---|---|---|---|---|---|---|
| | | Composition ratio (mass ratio) | | | | Slurry | Expression | Expression | battery |
| | | Electrode | Sulfide | | | NV | (1) | (2) | Battery |
| | Positive electrode | active | solid | Conductive | | value | X₀ | [ΔX] | resistance |
| | active material | material | electrolyte | material | Binder | [mass %] | [−] | [%] | [Ω] |
| Comp. Ex. 9 | Li(Ni_{0.8}Co_{0.15}Al_{0.05})O₂ | 0.600 | 0.300 | 0.050 | 0.050 | 71 | 2.0 | 2 | 11.3 |
| Comp. Ex. 10 | Li(Ni_{0.8}Co_{0.15}Al_{0.05})O₂ | 0.600 | 0.300 | 0.050 | 0.050 | 55 | 2.0 | 25 | 10.5 |
| Ex. 11 | Li(Ni_{0.8}Co_{0.15}Al_{0.05})O₂ | 0.631 | 0.289 | 0.040 | 0.040 | 71 | 2.2 | 2 | 5.1 |
| Ex. 12 | Li(Ni_{0.8}Co_{0.15}Al_{0.05})O₂ | 0.631 | 0.289 | 0.040 | 0.040 | 55 | 2.2 | 25 | 8.9 |
| Comp. Ex. 11 | Li(Ni_{0.8}Co_{0.15}Al_{0.05})O₂ | 0.631 | 0.289 | 0.040 | 0.040 | 41 | 2.2 | 26 | 10.6 |
| Ex. 13 | Li(Ni_{0.8}Co_{0.15}Al_{0.05})O₂ | 0.853 | 0.057 | 0.050 | 0.040 | 71 | 15.0 | 2 | 4.2 |
| Ex. 14 | Li(Ni_{0.8}Co_{0.15}Al_{0.05})O₂ | 0.853 | 0.057 | 0.050 | 0.040 | 55 | 15.0 | 25 | 6.1 |
| Comp. Ex. 12 | Li(Ni_{0.8}Co_{0.15}Al_{0.05})O₂ | 0.853 | 0.057 | 0.050 | 0.040 | 41 | 15.0 | 26 | 9.7 |
| Comp. Ex. 13 | Li(Ni_{0.8}Co_{0.15}Al_{0.05})O₂ | 0.900 | 0.050 | 0.020 | 0.030 | 71 | 18.0 | 2 | 11.2 |
| Comp. Ex. 14 | Li(Ni_{0.8}Co_{0.15}Al_{0.05})O₂ | 0.900 | 0.050 | 0.020 | 0.030 | 55 | 18.0 | 25 | 10.3 |

«Results»

As illustrated in Table 2 above, when the electrode active material layer satisfies the expression (1) and the expression (2), battery resistance tends to be low.

### Experiment 3: Comparative Example 15 to Comparative Example 20, Example 15 to Example 18

In Experiment 3, a positive electrode was evaluated.

«Producing All-Solid-State Battery»

Except that “Positive electrode active material”, “Composition ratio”, and “NV value” were changed as specified in Table 3 below, the same manner as in Experiment 1 was adopted to produce an electrode and an all-solid-state battery.

«Evaluation»

In the same manner as in Experiment 1, “X₀” and “|ΔX|” for the positive electrode as well as battery resistance were measured. Results are shown in Table 3 below. In Experiment 3, the electrode active material included P and therefore the S mass concentration alone was regarded as the mass concentration of the second component.

TABLE 3

| | Electrode active material layer | | | | | | | | All-solid-state |
|---|---|---|---|---|---|---|---|---|---|
| | Positive | Composition ratio (mass ratio) | | | | Slurry | Expression | Expression | battery |
| | electrode | Electrode | Sulfide | | | NV | (1) | (2) | Battery |
| | active | active | solid | Conductive | | value | X₀ | [ΔX] | resistance |
| | material | material | electrolyte | material | Binder | [mass %] | [−] | [%] | [Ω] |
| Comp. Ex. 15 | LiFePO₄ | 0.600 | 0.300 | 0.050 | 0.050 | 71 | 2.0 | 2 | 10.9 |
| Comp. Ex. 16 | LiFePO₄ | 0.600 | 0.300 | 0.050 | 0.050 | 55 | 2.0 | 25 | 9.7 |
| Ex. 15 | LiFePO₄ | 0.635 | 0.285 | 0.040 | 0.040 | 71 | 2.2 | 2 | 4.8 |
| Ex. 16 | LiFePO₄ | 0.635 | 0.285 | 0.040 | 0.040 | 55 | 2.2 | 25 | 7.2 |
| Comp. Ex. 17 | LiFePO₄ | 0.635 | 0.285 | 0.040 | 0.040 | 41 | 2.2 | 26 | 11.2 |
| Ex. 17 | LiFePO₄ | 0.853 | 0.057 | 0.050 | 0.040 | 71 | 15.0 | 2 | 4.9 |
| Ex. 18 | LiFePO₄ | 0.853 | 0.057 | 0.050 | 0.040 | 55 | 15.0 | 25 | 8.0 |
| Comp. Ex. 18 | LiFePO₄ | 0.853 | 0.057 | 0.050 | 0.040 | 41 | 15.0 | 26 | 10.7 |
| Comp. Ex. 19 | LiFePO₄ | 0.900 | 0.050 | 0.020 | 0.030 | 71 | 18.0 | 2 | 12.3 |
| Comp. Ex. 20 | LiFePO₄ | 0.900 | 0.050 | 0.020 | 0.030 | 55 | 18.0 | 25 | 11.1 |

«Results»

As illustrated in Table 3 above, when the electrode active material layer satisfies the expression (1) and the expression (2), battery resistance tends to be low.

### Experiment 4: Comparative Example 21 to Comparative Example 26, Example 19 to Example 22

In Experiment 4, a negative electrode was evaluated.

«Producing All-Solid-State Battery»

The materials described below were prepared.

Electrode active material: Li₄Ti₅O₁₂

Sulfide solid electrolyte: 10LiI-10LiBr-80(0.75Li₂S-0.25P₂S₅)

Conductive material: acetylene black, VGCF

Binder: PVdF

Dispersion medium: butyl butyrate

Negative electrode current collector: Ni foil

The binder, the conductive material, the sulfide solid electrolyte, and the electrode active material were added to the dispersion medium in this order. More specifically, the materials were added to the dispersion medium in descending order of specific surface area. Each time a material was added, the material was dispersed with an ultrasonic homogenizer. Each dispersion operation with an ultrasonic homogenizer was continued until the particle size reached 40 μm or less. In this way, a slurry was prepared. At all times from the start of material addition to the completion of slurry, the temperature of the dispersion system was controlled at 45° C. or lower.

The slurry was applied to a surface of a negative electrode current collector and dried to form an electrode active material layer. In this way, a negative electrode was produced.

“Composition ratio” and “NV value” of the slurry were changed as specified in Table 4 below to produce a negative electrode according to each Example. Then, in the same manner as in Experiment 1, an all-solid-state battery according to each Example was produced.

«Evaluation»

In the same manner as in Experiment 1, “X₀” and “|ΔX|” for the negative electrode as well as battery resistance were measured. Results are shown in Table 4 below.

TABLE 4

| | Electrode active material layer | | | | | | | | All-solid-state |
|---|---|---|---|---|---|---|---|---|---|
| | Negative | Composition ratio (mass ratio) | | | | Slurry | Expression | Expression | battery |
| | electrode | Electrode | Sulfide | | | NV | (1) | (2) | Battery |
| | active | active | solid | Conductive | | value | X₀ | [ΔX] | resistance |
| | material | material | electrolyte | material | Binder | [mass %] | [−] | [%] | [Ω] |
| Comp. Ex. 21 | Li₄Ti₅O₁₂ | 0.600 | 0.300 | 0.050 | 0.050 | 63 | 2.0 | 2 | 11.2 |
| Comp. Ex. 22 | Li₄Ti₅O₁₂ | 0.600 | 0.300 | 0.050 | 0.050 | 35 | 2.0 | 25 | 10.5 |
| Ex. 19 | Li₄Ti₅O₁₂ | 0.630 | 0.262 | 0.050 | 0.058 | 63 | 2.4 | 2 | 4.7 |
| Ex. 20 | Li₄Ti₅O₁₂ | 0.630 | 0.262 | 0.050 | 0.058 | 35 | 2.4 | 25 | 8.1 |
| Comp. Ex. 23 | Li₄Ti₅O₁₂ | 0.630 | 0.262 | 0.050 | 0.058 | 25 | 2.4 | 26 | 12.0 |
| Ex. 21 | Li₄Ti₅O₁₂ | 0.883 | 0.059 | 0.030 | 0.028 | 63 | 15.0 | 2 | 5.0 |
| Ex. 22 | Li₄Ti₅O₁₂ | 0.883 | 0.059 | 0.030 | 0.028 | 35 | 15.0 | 25 | 8.7 |
| Comp. Ex. 24 | Li₄Ti₅O₁₂ | 0.883 | 0.059 | 0.030 | 0.028 | 25 | 15.0 | 26 | 11.6 |
| Comp. Ex. 25 | Li₄Ti₅O₁₂ | 0.900 | 0.050 | 0.020 | 0.030 | 63 | 18.0 | 2 | 12.0 |
| Comp. Ex. 26 | Li₄Ti₅O₁₂ | 0.900 | 0.050 | 0.020 | 0.030 | 35 | 18.0 | 25 | 12.9 |

«Results»

As illustrated in Table 4 above, when the electrode active material layer satisfies the expression (1) and the expression (2), battery resistance tends to be low.

### Experiment 5: Comparative Example 27 to Comparative Example 32, Example 23 to Example 26

In Experiment 5, a negative electrode was evaluated.

«Producing All-Solid-State Battery»

Except that “Negative electrode active material”, “Composition ratio”, and “NV value” were changed as specified in Table 5 below, the same manner as in Experiment 4 was adopted to produce an electrode and an all-solid-state battery.

«Evaluation»

In the same manner as in Experiment 1, “X₀” and “|ΔX|” for the negative electrode as well as battery resistance were measured. Results are shown in Table 5 below.

TABLE 5

| | Electrode active material layer | | | | | | | | All-solid-state |
|---|---|---|---|---|---|---|---|---|---|
| | Negative | Composition ratio (mass ratio) | | | | Slurry | Expression | Expression | battery |
| | electrode | Electrode | Sulfide | | | NV | (1) | (2) | Battery |
| | active | active | solid | Conductive | | value | X₀ | [ΔX] | resistance |
| | material | material | electrolyte | material | Binder | [mass %] | [−] | [%] | [Ω] |
| Comp. Ex. 27 | Si | 0.600 | 0.300 | 0.050 | 0.050 | 63 | 2.0 | 2 | 11.1 |
| Comp. Ex. 28 | Si | 0.600 | 0.300 | 0.050 | 0.050 | 35 | 2.0 | 25 | 9.1 |
| Ex. 23 | Si | 0.630 | 0.262 | 0.050 | 0.060 | 63 | 2.4 | 2 | 4.0 |
| Ex. 24 | Si | 0.630 | 0.262 | 0.050 | 0.060 | 35 | 2.4 | 25 | 7.9 |
| Comp. Ex. 29 | Si | 0.630 | 0.262 | 0.050 | 0.060 | 25 | 2.4 | 26 | 10.2 |
| Ex. 25 | Si | 0.883 | 0.059 | 0.030 | 0.028 | 63 | 15.0 | 2 | 4.6 |
| Ex. 26 | Si | 0.883 | 0.059 | 0.030 | 0.028 | 35 | 15.0 | 25 | 7.2 |
| Comp. Ex. 30 | Si | 0.883 | 0.059 | 0.030 | 0.028 | 25 | 15.0 | 26 | 10.7 |
| Comp. Ex. 31 | Si | 0.900 | 0.050 | 0.020 | 0.030 | 63 | 18.0 | 2 | 11.9 |
| Comp. Ex. 32 | Si | 0.900 | 0.050 | 0.020 | 0.030 | 35 | 18.0 | 25 | 11.7 |

«Results»

As illustrated in Table 5 above, when the electrode active material layer satisfies the expression (1) and the expression (2), battery resistance tends to be low.

The present embodiments and the present examples are illustrative in any respect. The present embodiments and the present examples are non-restrictive. The technical scope defined by the terms of the claims encompasses any modifications within the meaning equivalent to the terms of the claims. The technical scope defined by the terms of the claims encompasses any modifications within the scope equivalent to the terms of the claims.

What is claimed is:

1. An electrode comprising:
an electrode current collector; and
an electrode active material layer,
the electrode active material layer being formed on a surface of the electrode current collector,
the electrode active material layer including an electrode active material and a sulfide solid electrolyte,
the electrode active material including a first component,
the first component consisting of at least one selected from the group consisting of nickel, cobalt, manganese, aluminum, iron, titanium, and silicon,
the sulfide solid electrolyte including a second component,
the second component consisting of sulfur and phosphorus,
the electrode active material layer satisfying relations represented by the following expression (1) and the following expression (2):
2.2≤X₀≤15.0 (1)

|(X₅−X₁)/X₁|25% (2)
in the expression (1), X₀ represents a ratio of a mass concentration of the first component to a mass concentration of the second component in a region of a cross section of the electrode active material layer parallel to a thickness direction of the electrode active material layer, where the region stretches for an entire thickness of the electrode active material layer,
in the expression (2), X₁ represents a ratio of a mass concentration of the first component to a mass concentration of the second component in a region of the cross section, where the region is associated with a single unit layer among five unit layers that result from equally dividing the electrode active material layer in the thickness direction and the single unit layer is the closest to the electrode current collector among the five unit layers,
X₅ represents a ratio of a mass concentration of the first component to a mass concentration of the second component in a region of the cross section, where the region is associated with a single unit layer that is the farthest from the electrode current collector among the five unit layers,
when the electrode active material does not include phosphorus, the mass concentration of the second component being defined as a sum of a mass concentration of sulfur and a mass concentration of phosphorus, and
when the electrode active material includes phosphorus, the mass concentration of the second component being defined as the mass concentration of sulfur.

2. The electrode according to claim 1, wherein
the electrode active material is a positive electrode active material, and
the positive electrode active material includes at least one selected from the group consisting of a lithium-nickel-cobalt-manganese composite oxide, a lithium-nickel-cobalt-aluminum composite oxide, and a lithium iron phosphate.

3. The electrode according to claim 1, wherein
the electrode active material is a negative electrode active material, and
the negative electrode active material includes at least one selected from the group consisting of a lithium-titanium composite oxide, a silicon oxide, and silicon.

4. An all-solid-state battery comprising the electrode according to claim 1.
